(19) United States
(12) Patent Application Publication
(10) Pub. No.: US 2008/0098835 A1
(43) Pub. Date: May 1, 2008

(54) Torque controlling device for linear actuator

(75) Inventor: Fu-Yuan Cheng, Taichung (TW)

Correspondence Address: CHARLES E. BAXLEY, ESQ., 90 JOHN STREET, THIRD FLOOR, NEW YORK, NY, 10038, US

(73) Assignee: Hiwin Mikrosystem Corp.

(21) Appl. No.: 11/589,640

(22) Filed: Oct. 30, 2006

(51) Int. Cl. F16H 27/02; F16H 29/02

(52) U.S. Cl. 74/89.38

(57) ABSTRACT

A torque controlling device for being equipped around a motor shaft and providing warning to an operator of idle running of the motor and allowing the operator to adjust for proper torque control thereby at least comprises a ball settled on the surface of the motor shaft, a through passage radially passing through the worm shaft accommodating said ball, an elastic element arranged upon the ball and a screw provided upon the elastic element.

### BACKGROUND OF THE INVENTION

1. Technical Field

The present invention is related to linear actuators, and more particularly, to a torque controlling device provided between a motor shaft and a worm shaft of a linear actuator.

2. Description of Related Art

A linear actuator which works by implementing a motor to drive a worm shaft and in turn rotate a worm gear to accomplish linear propelling has been commonly used in industries of nowadays. A conventional worm gearing system, as shown in FIGS. 1 and 2, primarily comprises a motor 70, a motor shaft 71, a worm shaft 80 operatively connected to said motor shaft 71 and a worm gear 90 which can be driven by the worm shaft 80. In the exemplificative conventional worm gearing system, the worm shaft 80 and worm gear 90 mesh with each other perpendicularly, and the worm gear 90 may further propel a power cylinder to move linearly. It is the operational principle of a linear actuator.

However, during operation, once the distal portion of the linear actuator encounters excessive obstructive force, the obstructive force may pass return to interfere with the rotating of the worm gear 90 and worm shaft 80 and as a result, render the motor shaft 71 jammed or the worm gear 90 damaged. In prior art, an operator may use an electronic current controller to monitor the instant operational current and set an electric current limit to accomplish a normal load torque control. Thus, when the machine encounters excessive obstructive force, the instant operational current shall be sharply increased, and the motor can be shut when said electric current limit is reached. Therefore, the ill effects caused by motor over-loaded can be avoided.

However, said controlling means of electronic current controller may require expensive costs and yet have deficiency. As a motor and the peripheral devices of a linear actuator can get heated over operational time and the temperature change may cause influence on the instant operational current reads, the inaccuracy of instant operational current reads may in turn result in improper load torque control. Consequently, waste of kinetic energy and wear of devices can be caused. Thereupon, the useful life of the motor 70 may be undesirably shortened or the motor may burn out during operation to endanger the operators and peripheral devices.

### SUMMARY OF THE INVENTION

The present invention has been accomplished under the circumstances in view and provides a torque controlling device for being equipped around a motor shaft and providing warning to an operator of idle running of the motor and allowing the operator to adjust for proper torque control thereby. Said torque controlling device comprises a ball settled on the surface of the motor shaft, an elastic element arranged upon the ball and a screw provided upon the elastic element.

It is one object of the present invention to provide a torque controlling device, which dispenses with the need of an expensive electronic current controller and achieves load torque control economically and efficiently.

It is another object of the present invention to provide a torque controlling device, which provides warning to an operator when idle running of the motor occurs by the clank generated during the ball moving up and down against the surface of motor shaft, so that the operator can modify torque control by adjusting the disclosed torque controlling device immediately.

It is another object of the present invention to provide a torque controlling device, which implements uncomplex structure to accomplish torque adjustment without needs of additional space and device costs.

It is another object of the present invention to provide a torque controlling device, which allows an operator easily and promptly adjusting the resistance put onto the ball by screwing the screw to maintain normal operation of the linear actuator.

It is yet another object of the present invention to provide a torque controlling device, which eliminates the detrimental influence inaccuracy caused by temperature change over operational time and accomplish reliable load torque control.

It is still another object of the present invention to provide a torque controlling device, which protects the motor and peripheral devices form damage caused by excessive load and in turn facilitates extending the useful life thereof.

### BRIEF DESCRIPTION OF THE DRAWINGS

The invention as well as a preferred mode of use, further objectives and advantages thereof, will best be understood by reference to the following detailed description of an illustrative embodiment when read in conjunction with the accompanying drawings, wherein:

FIG. 1 is a lateral view of a conventional worm gearing system on a linear actuator;

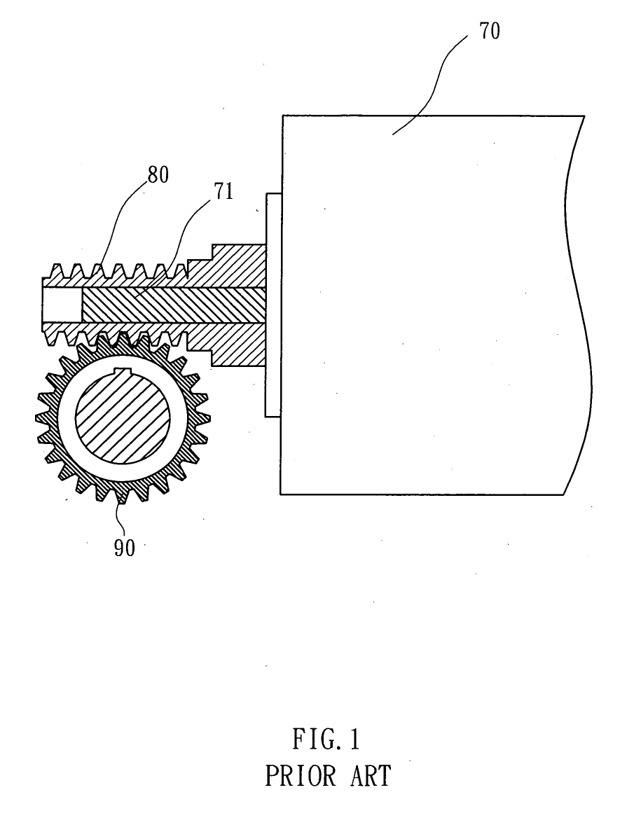

FIG. 2 is a front view of the worm gearing system according to FIG. 1;

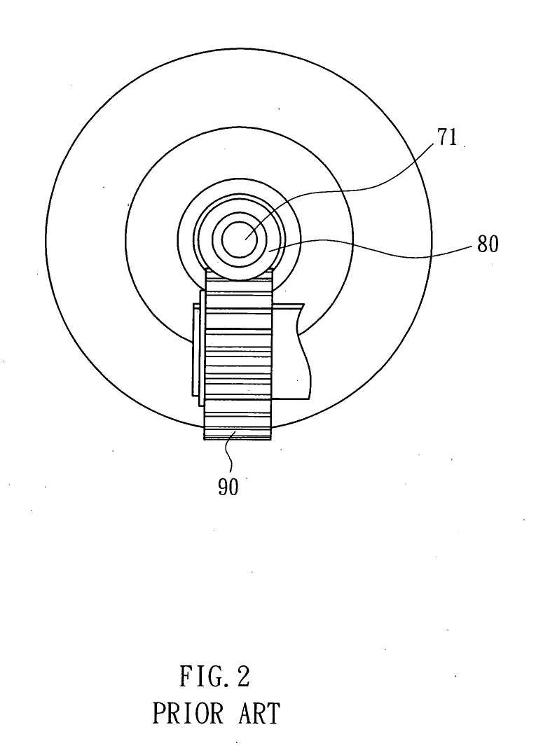

FIG. 3 is a lateral view of a worm gearing system equipped to a linear actuator according to the present invention;

FIG. 4 is a sectional view taken in an enlarged scale along Line 4-4 of FIG. 3;

FIG. 5 is an applied view showing the torque controlling device according to the present invention under an overload condition of FIG. 4; and

FIG. 6 is an applied view showing the state of the torque controlling device in FIG. 5.

### DETAILED DESCRIPTION OF THE PREFERRED EMBODIMENT

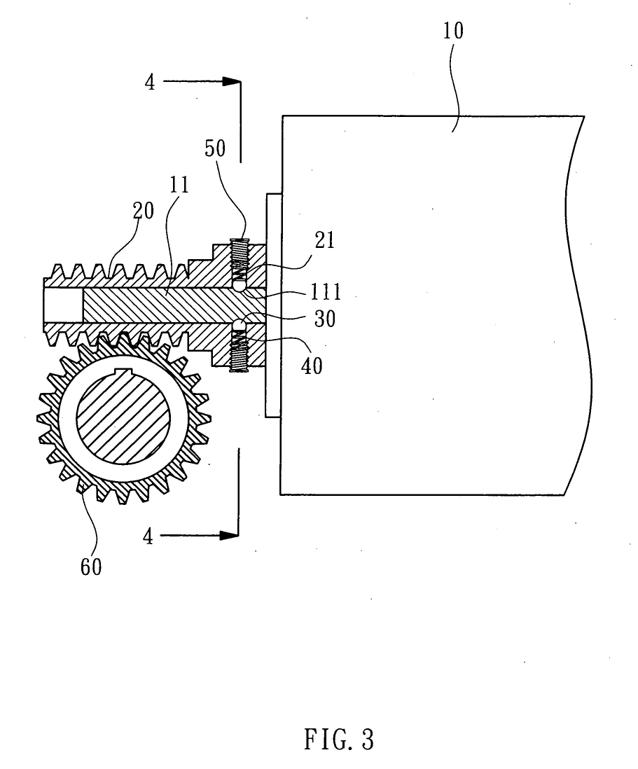

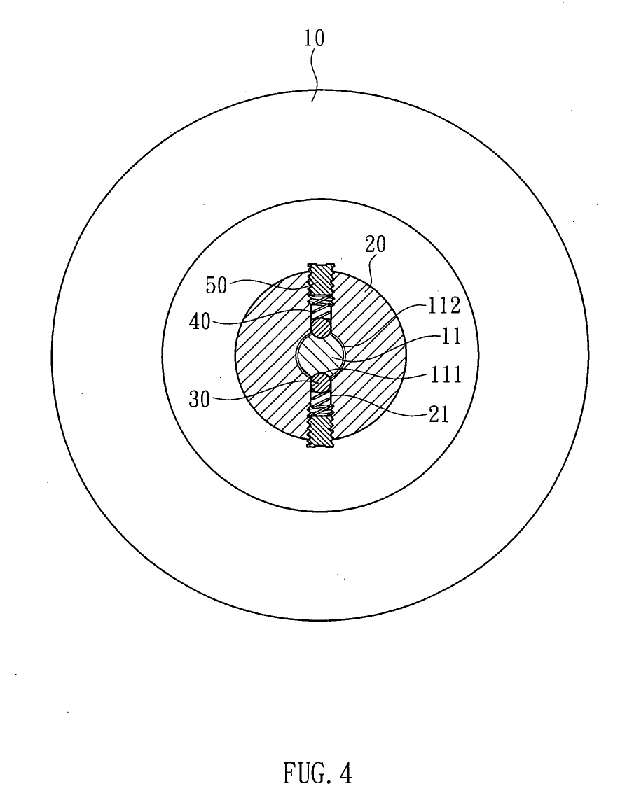

As shown in FIGS. 3 and 4, according to an embodiment of the present invention, the disclosed torque controlling device for a linear actuator comprises:

a motor 10,

a motor shaft 11 having a driving end,

a worm shaft 20 meshing sheathing said driving end of the motor shaft 11,

two relatively deeper ball seats 111 situated on the peripheral surface of the motor shaft 11 oppositely which are interconnected by a relatively shallower ball cannelure 112 encircling the motor shaft 11,

two through passages 21 provided radially through the worm shaft 20 and positioned correspondingly to said two ball seats 111 wherein each through passage 21 has internal threads at the end adjacent to the outer periphery of the worm shaft 20,

two balls 30, which according to the particular embodiment is are stainless round balls, each having one side thereof settled in one of said ball seats 111 on the motor shaft 11, while the other side thereof is received by the relevant through passage 21 at the end adjacent to the inner periphery of the worm shaft 20,

two elastic element 40 provided respectively in each said through passage 21 and sitting upon the ball 30, and

two screws 50, wherein each screw 50 is pierced into the through passage 21 from the external peripheral surface of the worm shaft 20 that has threads matching threads of the through passage 21 so that the screw 50 can be screwed into or back from the through passage 21.

By foregoing structure, each said screw 50 pushes the corresponding elastic element 40 to press on the surface of the corresponding ball 30 and successively makes the ball 30 presses tightly onto the surface of the ball seat 111.

Thus, during normal operation, the motor shaft 11 propels the worm shaft 20 to rotate, and said balls 30, elastic element 40 and screws 50 are synchronously drawn to move. Such motion of foresaid components further drives a worm gear 60 to impel a linear moving mechanism to perform linear reciprocation

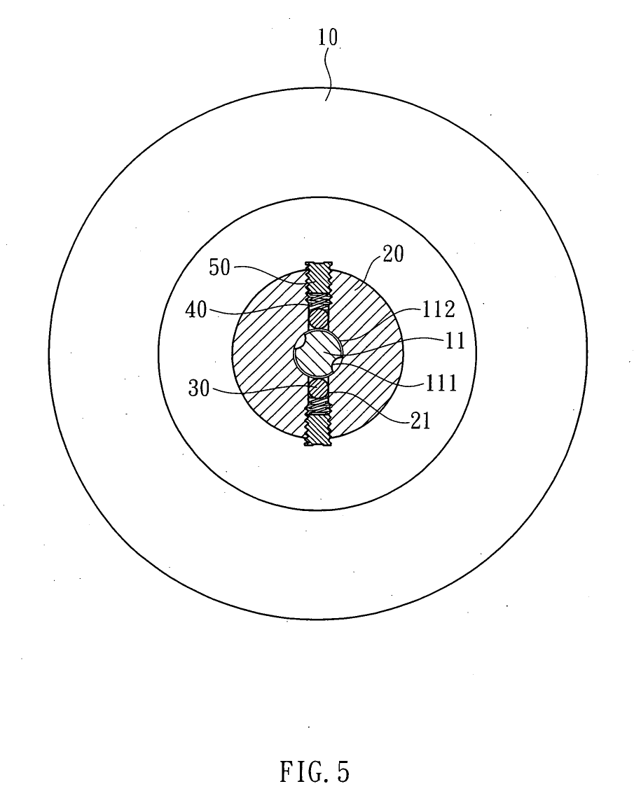

However, as the linear moving mechanism encounters excessive obstructive force that is passed return to impede the rotations of the worm gear 60 and worm shaft 20, the incipient torque set of the disclosed torque controlling device can not afford current load, idle running of the motor shaft 11 is therefore rendered. At this time, since each said ball 30 is located between running motor shaft 11 and immobile worm shaft 20, the upper end thereof is retained by the through passage 21 of worm shaft 20, while the bottom thereof is forced to moves upward and compresses the elastic element 40 to depart the ball seats 111 and contact with the relatively shallower ball cannelure 112, as shown in FIG. 5. Then, when each said ball seat 111 arrives at one of said through passages 21 again accompanying the rotation of the motor shaft 11, the ball 30 now sitting in the ball cannelure 112 once again falls in to the ball seat 111. Due to the height difference between the ball seat 111 and ball cannelure 112, the repeated reciprocating motion of the ball 30 gives intermittent clank. Such clank can function as warning to a machine operator for idle running of the motor shaft 11.

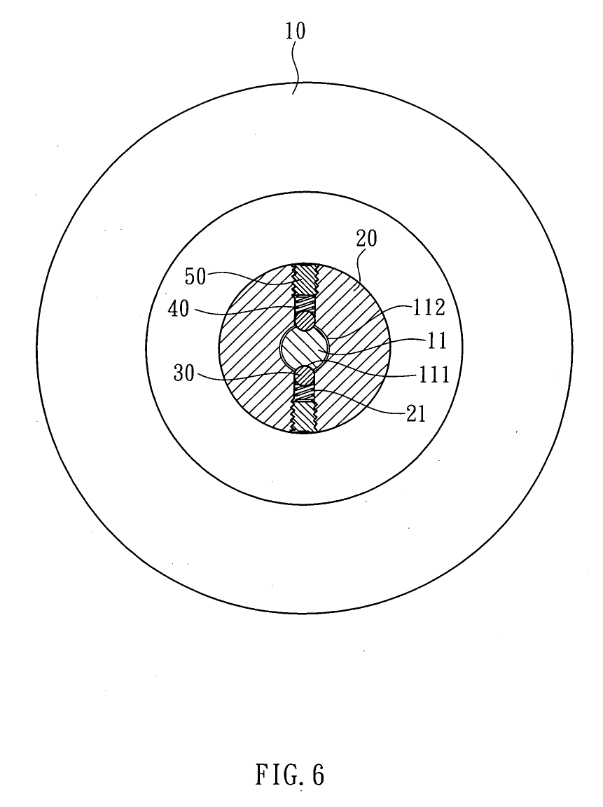

Accordingly, the torque of the motor 10 can be increased by screwing the screws 50 inward the through passages 21 equally, when the deepgoing screws 50 evenly compress the elastic elements 40 toward the motor shaft 11, as shown in FIG. 6, such centripetal compression counteracts said centrifugal compression coming from the balls 30 so that the balls 30 can return and stay in the ball seats 111 to be carried by the rotating motor shaft 11 and the worm shaft 20 in turn regains its driven rotation. Consequently, normal operation of the worm gearing system can be recovered.

Although a particular embodiment of the invention has been described in detail for purposes of illustration, it will be understood by one of ordinary skill in the art that numerous variations will be possible to the disclosed embodiments without going outside the scope of the invention as disclosed in the claims.

What is claimed is:

1. A torque controlling device for a linear actuator, which comprises a motor shaft having a driving end, and a worm shaft sheathing said driving end, characterized by:
at lease one ball seat arranged on the peripheral surface of the motor shaft,
at least one through passage provided radially through the worm shaft and having internal threads at the end adjacent to the outer periphery of the worm shaft,
at least one ball, having one side thereof settled in said ball seat, while the other side thereof received by said through passage at the end adjacent to the inner periphery of the worm shaft,
at least one screw pierced into the through passage from the external peripheral surface of the worm shaft that has threads matching threads of the through passage, and
at least one elastic element provided respectively in said through passage and having one end pressing tightly onto the said ball and the opposite end pressing tightly on the screw.

2. The torque controlling device as claimed in claim 1, wherein the screw can be screwed inward or outward the through passage.

3. The torque controlling device as claimed in claim 2, wherein the elastic element can be compressed or released between the screw and ball according to the position of the screw in the through passage.

4. The torque controlling device as claimed in claim 1, wherein the at least one ball seat is interconnected by at least one ball cannelure encircling the motor shaft.

5. The torque controlling device as claimed in claim 4, wherein the ball seat is slightly deeper than the ball cannelure.
